(19) United States
(12) Patent Application Publication
(10) Pub. No.: US 2013/0118972 A1
(43) Pub. Date: May 16, 2013

(54) FILTER SYSTEMS FOR BOTTLED WATER DISPENSERS

(71) Applicant: George Yui, Toronto (CA)

(72) Inventor: George Yui, Toronto (CA)

(21) Appl. No.: 13/294,163

(22) Filed: Nov. 10, 2011

(51) Int. Cl. B01D 27/08; B67D 7/76

(52) U.S. Cl. 210/323.1; 222/189.11; 210/444; 210/416.3

(57) ABSTRACT

Bottled water dispensers are disclosed that include a modular water filter, particularly bottom loading water dispensers that include a pump to move water through the water dispenser. The water filters include a bottom container with an open top end, and a cap portion with an open bottom end (which is configured to be attached to the open top end of the bottom container). The water filters also include an interior container which (i) resides within the interior area of the water filter when the bottom container and cap portion are connected to each other and (ii) includes one or more filters through which water may pass within the water filter. The water filter is modular and may be used and replaced within bottled water dispensers as needed.

### FIELD OF THE INVENTION

The present invention relates generally to the field of bottled water dispensers and, more particularly, to certain types of filter systems that are used in connection with bottled water dispensers, and particularly bottom loading water dispensers.

### BACKGROUND OF THE INVENTION

The demand for clean and healthy drinking water is increasing dramatically, which is being driven by the rapid growth in population and standards of living across the globe. This demand has translated into a continuing need for safe, clean, and easy to use water dispensers. An important aspect of any bottled water dispenser is the device and method that it uses to ensure that the drinking water is clean and safe to consume. While various methods and devices have been developed over the years to fill such role, water filters are among the more ubiquitously employed devices to clean drinking water—particularly water filters that rely on gravity to move water through the filters.

Indeed, there are various types of water filters used today for bottled water dispensers, most of which are gravity-flow filters. These gravity-dependent filters, however, limit the location and orientation of such filters in a bottled water dispenser system. Accordingly, despite the existence of such prior art filtering systems, there is a continuing need for improved filters (and related bottled water dispenser systems) that more effectively and efficiently clean drinking water prior to consumption.

As the following will demonstrate, the improved water filter systems and related bottled water dispensers of the present invention provide various significant advantageous over currently-available water filtering systems.

### SUMMARY OF THE INVENTION

According to certain aspects of the invention, bottled water dispensers (and, particularly, bottom loading water dispensers) are provided that include a cabinet, which has a top half and a bottom half. The invention provides that a water bottle may be positioned within the bottom, interior half of the cabinet. In addition, these bottled water dispensers will include a pump that is configured to force water out of the water bottle, through one or more tubes, and out of a water faucet that is accessible from an exterior of the water dispenser cabinet. Still further, the bottled water dispensers of the present invention will include a modular water filter, which may be reversibly inserted into and removed from an interior area of the cabinet. The invention provides that water will move through the filter in response to a force that is supplied by the pump—and not gravity forces (unlike most prior art filters and related water dispensers). Moreover, the invention provides that the filter may be located adjacent to or above the water bottle (since the filter does not rely upon gravitational forces to pull the water through the filter).

According to certain related aspects of the invention, bottled water dispensers (and, particularly, bottom loading water dispensers) are disclosed that include a modular water filter. The water filters includes a bottom container with an open top end, and a cap portion with an open bottom end (which is configured to be attached to the open top end of the bottom container). The water filters also include an interior container which (i) resides within the interior area of the water filter when the bottom container and cap portion are connected to each other and (ii) includes one or more filters through which water may pass within the water filter. The water filter is modular and may be used and replaced within bottled water dispensers as needed. The invention provides that the water dispenser includes a pump, which provides the necessary pressure to force water through the water filter during operation (and lends flexibility to the location and orientation of the water filter within the bottled water dispenser).

According to certain additional aspects of the present invention, modular water filters and connectors are provided, which are adapted to be inserted into a bottled water dispenser. According to such embodiments, as explained above, the water filter comprises a bottom container with an open top end, and a cap portion with an open bottom end (which is configured to be attached to the open top end of the bottom container). Similar to the embodiment described above, the filter also comprises an interior container that resides within an interior area of the water filter when the bottom container and cap portion are connected to each other, with the interior container being equipped with one or more filters through which water may pass. The invention further encompasses a connector, which is configured to reversibly receive and be attached to a mouth portion of the cap portion of the water filter. The connector-water filter combination may be disposed inside the bottled water dispenser, wherein water is forced through a channel located in the connector and into the water filter vis-à-vis pressure that is provided by a pump.

The above-mentioned and additional features of the present invention are further illustrated in the Detailed Description contained herein.

### BRIEF DESCRIPTION OF THE FIGURES

FIG. 1: An illustration of a bottom loading water dispenser, which shows the preferred location of the water filter described herein.

FIG. 2: An illustration of a water filter that is used the present invention, disengaged and separated from its connector and the bottom loading water dispenser of FIG. 1.

FIG. 3: An illustration of a water filter connector, and a cap portion of a water filter that is used in the present invention.

FIG. 4: An illustration of a disassembled water filter that is described herein.

FIG. 5: An illustration of a disassembled water filter that is described herein, showing the interior container inserted into the bottom opening (into the secondary cylinder) of the cap portion.

FIG. 6: An illustration of a disassembled water filter that is described herein, showing (A) the interior of the bottom container; (B) the top end of the interior container; and (C) the interior of the cap portion (i.e., the bottom end of the cap portion).

FIG. 7: An illustration of a disassembled water filter that is described herein, showing (A) the interior of the bottom container; (B) the bottom end of the interior container; and (C) the top end of the cap portion.

FIG. 8: An illustration of a water filter connector and a water filter attached to each other.

FIG. 9: (A) A side view of a water filter connector and a water filter attached thereto; (B) A front view of a water filter connector and a water filter attached thereto.

FIG. 10: A cross-sectional view of a water filter connector and a water filter attached to each other, which diagrams the path of water through the connector and water filter, as described herein.

### DETAILED DESCRIPTION OF THE INVENTION

The following will describe in detail several preferred embodiments of the present invention. These embodiments are provided by way of explanation only, and thus, should not unduly restrict the scope of the invention. In fact, those of ordinary skill in the art will appreciate upon reading the present specification and viewing the present drawings that the invention teaches many variations and modifications, and that numerous variations of the invention may be employed, used and made without departing from the scope and spirit of the invention.

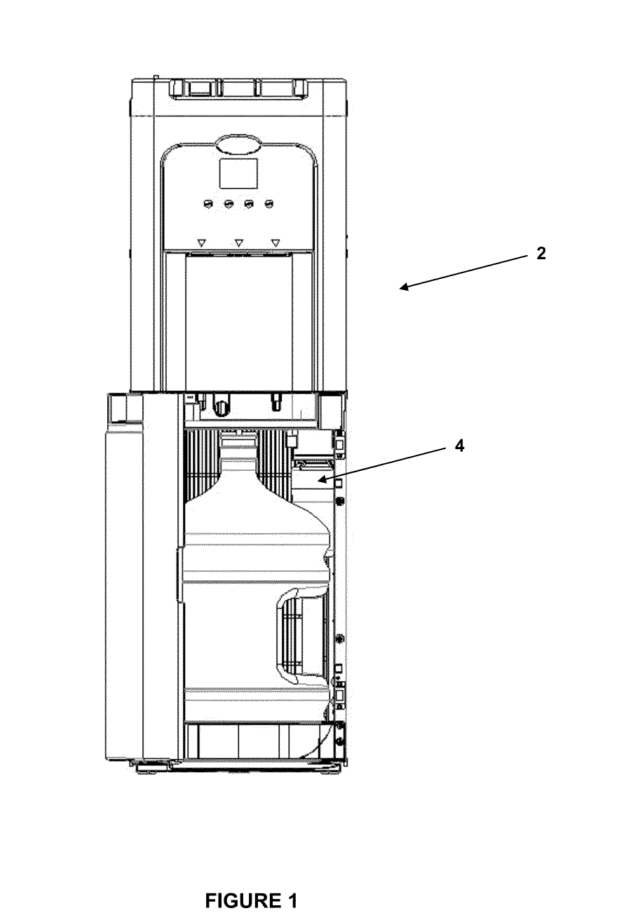

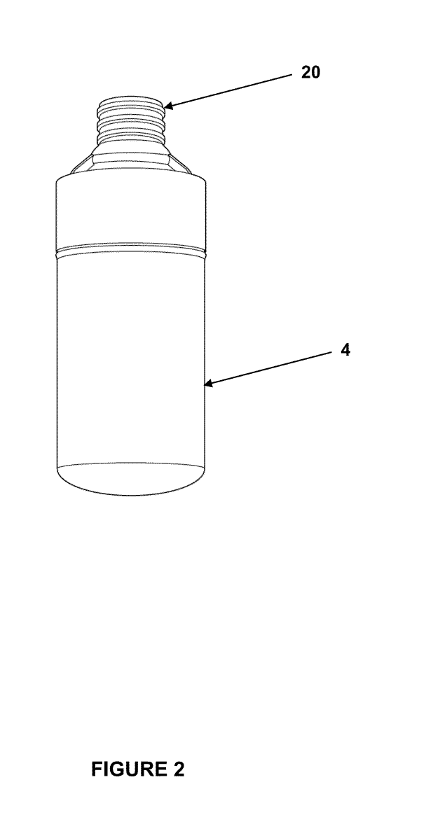

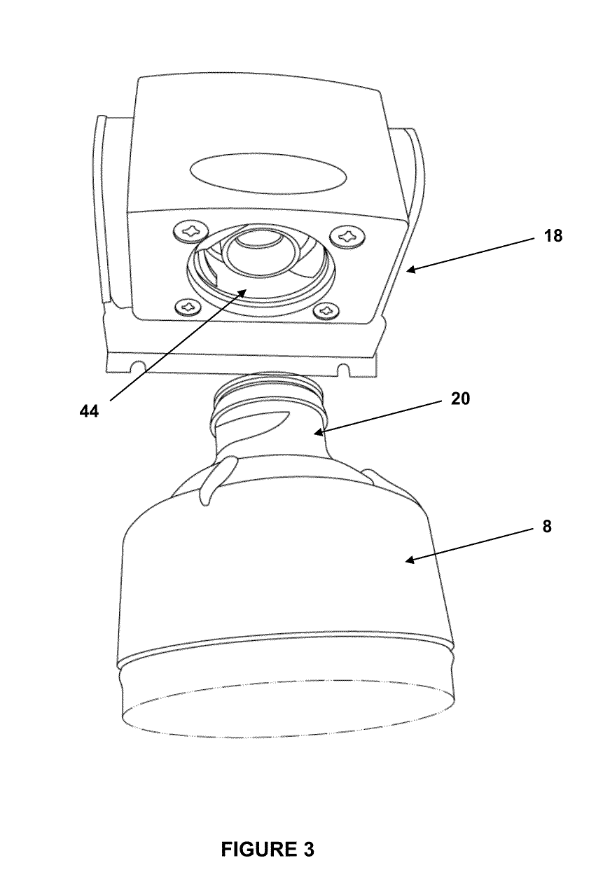

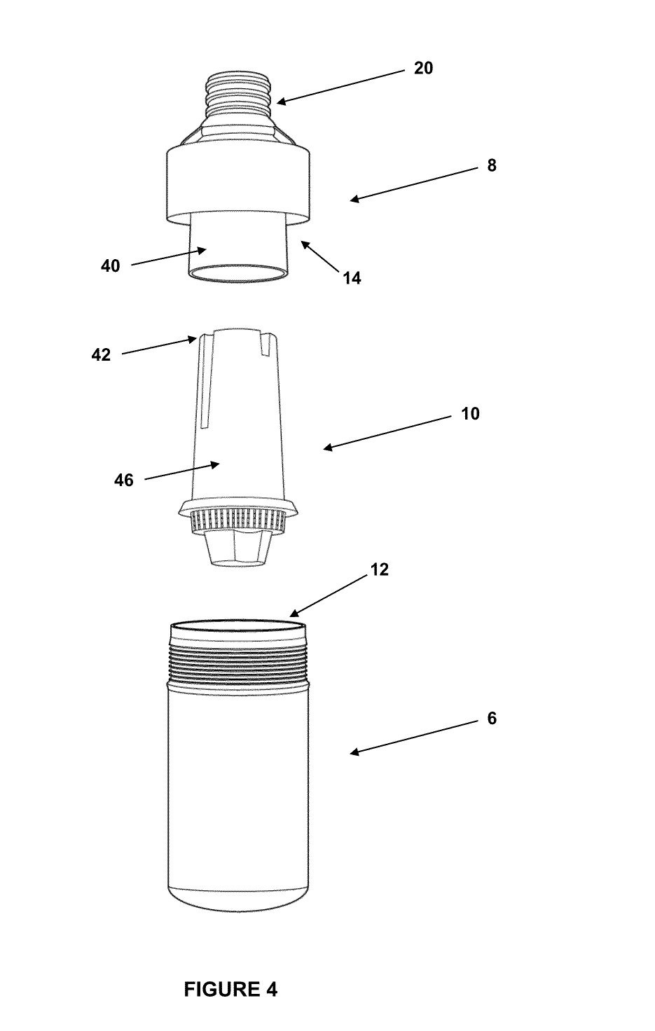

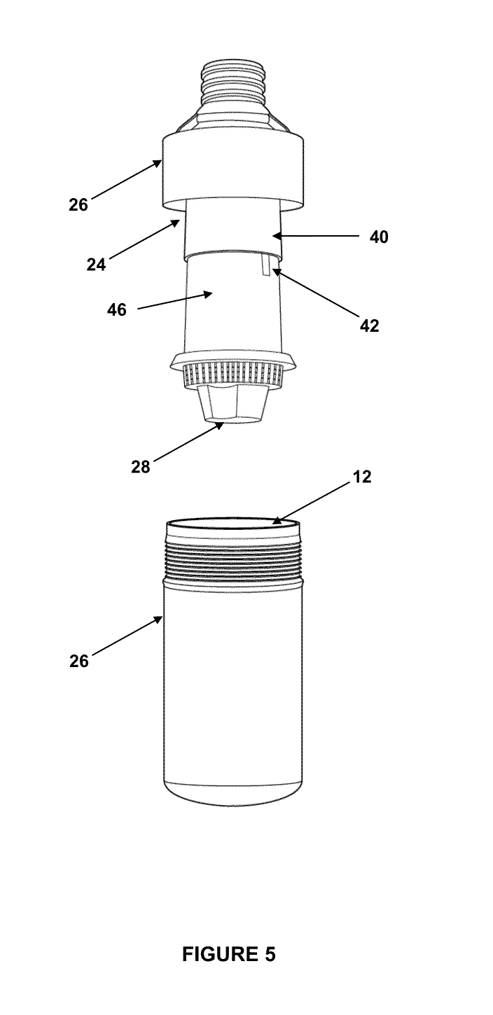

Referring now to FIGS. 1-10, the invention comprises a bottled water dispenser 2 that comprises a modular water filter 4. The term “modular,” as used herein, means that the water filter 4 may be inserted into the bottled water dispenser 2, used to filter drinking water as described herein, and later removed and replaced with a new water filter 4 when the first water filter 4 has expired (i.e., reached the end of its useful life and ability to adequately filter water).

Referring to FIG. 1, the bottled water dispensers 2 of the present invention will preferably comprise a cabinet, which has a top half and a bottom half. The invention provides that a water bottle may be positioned within the bottom, interior half of the cabinet. In addition, these bottled water dispensers 2 will include a pump that is configured to force water out of the water bottle, through one or more tubes, and out of a water faucet that is accessible from an exterior of the water dispenser cabinet. Still further, the bottled water dispensers of the present invention will include a modular water filter 4, which may be reversibly inserted into and removed from an interior area of the cabinet. The invention provides that water will move through the filter 4 in response to a force that is supplied by the pump (located inside the water dispenser cabinet)—and not gravity forces (unlike most prior art filters and related water dispensers). Moreover, the invention provides that the filter 4 may be located adjacent to or above the water bottle, since the filter 4 does not rely upon gravitational forces to pull the water through the filter 4, as shown in FIG. 1. In addition to having a self-contained source of force to push water through the filter 4, the invention provides that the water dispensers 2 of the present invention utilize bottled water (i.e., self-contained sources of water that can be easily replenished or replaced when the water is depleted from a water bottle)—and do not rely upon tapping into a local water line to access water (which is more expensive and can lead to water leaks).

According to certain specific embodiments, the invention provides that the water filter 4 comprises three primary components, namely, a bottom container 6, a cap portion 8, and an interior container 10. These components may be constructed from plastic, stainless steel, or other suitable materials (or combinations of such materials). The invention provides that the bottled water dispenser 2 is preferably a bottom loading water dispenser, meaning that the water bottle is positioned within the bottom half of the water dispenser (e.g., within an interior lower half of a cabinet, and located near a floor surface), as illustrated in FIG. 1.

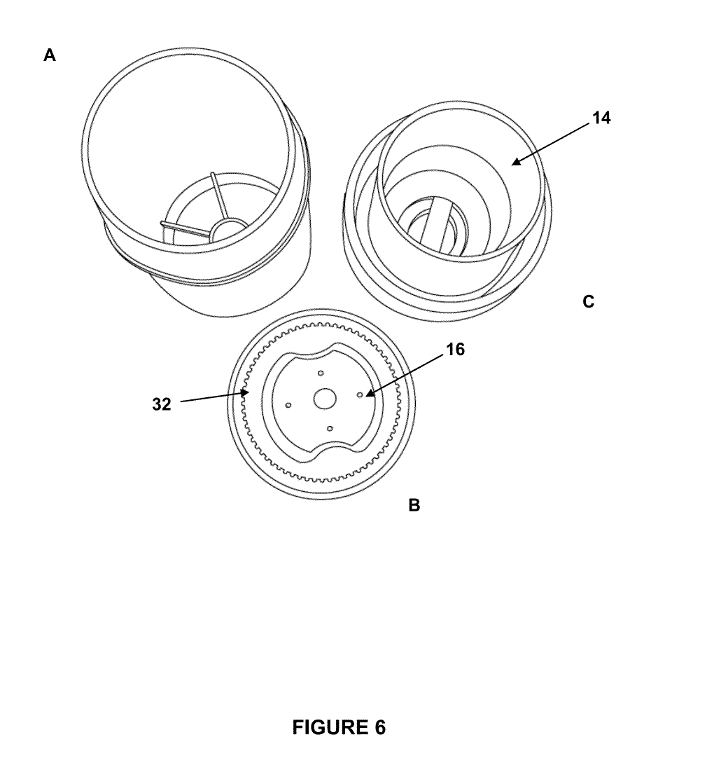

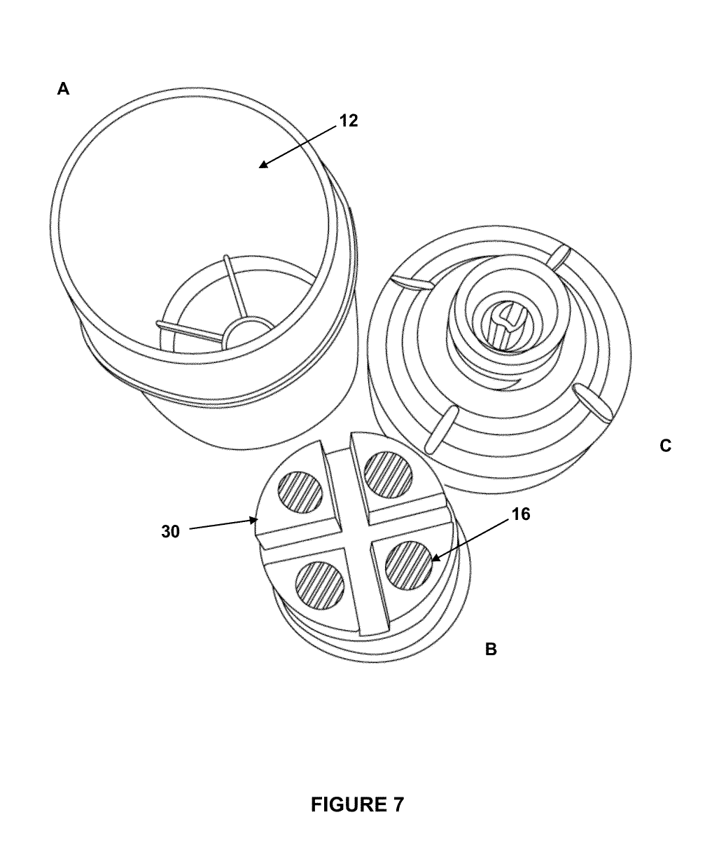

The bottom container 6 has a open top end 12, and the cap portion 8 exhibits an open bottom end 14 that is configured to be attached to the open top end 12 of the bottom container 6. The cap portion 8 may be attached to the open top end 12 of the bottom container 6 by corresponding threads (i.e., the cap portion 8 may be screwed onto the bottom container 6) or, alternatively, such components may be snapped together (or otherwise attached to each other through other mechanical means). The interior container 10 is configured to reside within an interior area of the water filter 4 when the bottom container 6 and cap portion 8 are connected to each other. The invention provides that the interior container 10 will comprise one or more filters 16 (FIGS. 6 and 7) through which water may pass within the water filter 2. The one or more filters 16 may comprise carbon filters, sediment filters, alkaline filters, or a combination of the foregoing filters. The cap portion 8 will preferably comprise an interior secondary cylinder 40, located within and accessible from the open bottom end 14 of the cap portion 8, which is configured to receive and connect to a top end 42 of the interior container 10. The interior secondary cylinder 40 may receive and frictionally connect to a top end 42 of the interior container 10 or, alternatively, such components may be screwed or snapped together.

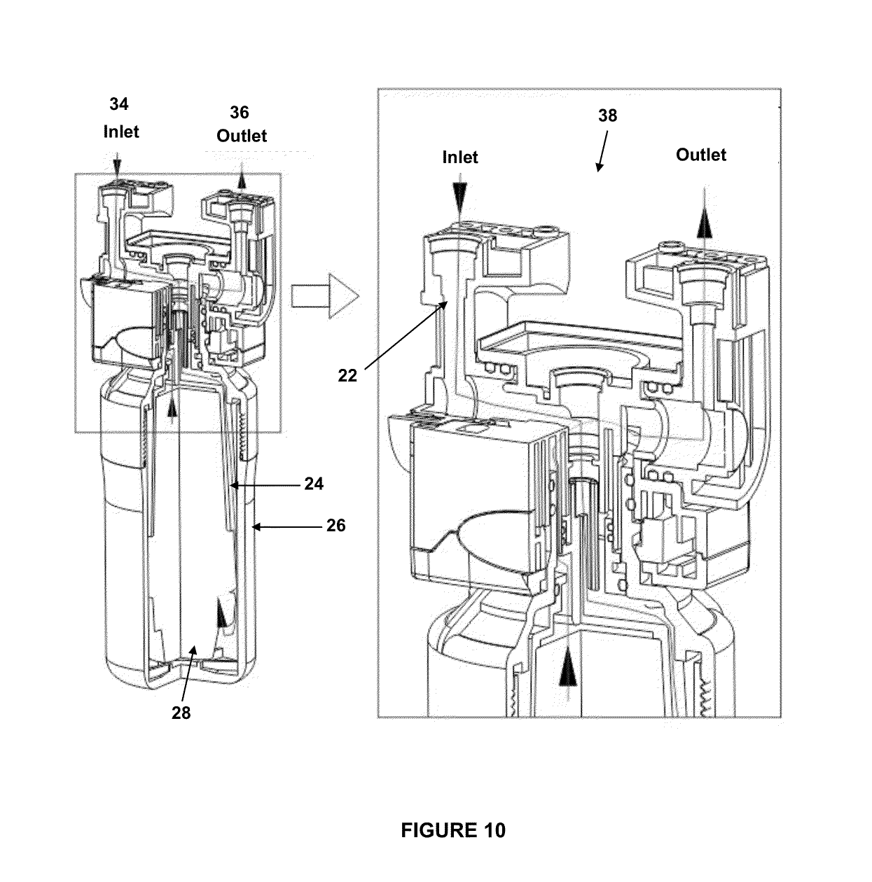

The invention further encompasses a water filter connector 18, which is configured to reversibly receive and be attached to a mouth portion 20 of the cap portion 8. The mouth portion 20 of the cap portion 8 may be threaded, and adapted to be screwed into a correspondingly threaded area 44 of the connector 18. The invention provides that a water inlet port 34 and a water outlet port 36 (FIG. 10) are both located on a topside 38 of the connector 18. The invention provides that water is allowed to travel through the water inlet port 34 and into a channel 22 (FIG. 10) located in the connector 18—and then into the water filter 4. More particularly, the invention provides that the water filter 2 will comprise a space 24 between (a) an outer wall 26 that is formed when the bottom container 6 and cap portion 8 are connected to each other and (b) the exterior surface 46 of the interior container 10. As such, water is allowed to travel through the channel 22 and into this space 24 and, eventually, into an interior area 28 of the interior container 10. The invention provides that the water will enter the interior area 28 of the interior container 10 through an open bottom end of the interior container 10. After reaching the interior area 28 of the interior container 10, the water may exit the interior area 28 (at the top end of the interior container 10) by traveling through one or more filters 16, such as four filters 16, and eventually exit through the water outlet port 36.

According to certain preferred embodiments, the invention provides that each of the one or more filters 16 will exhibit a larger surface area on a side 30 through which water enters, relative to a side 32 through which water exits each of the one or more filters 16. For example, referring to FIGS. 6 and 7, the filters 16 exhibit a larger diameter (and surface area) on the side 30 through which water enters, compared to the size of the same filters 16 located on the side 32 through which water exits each of such filters 16.

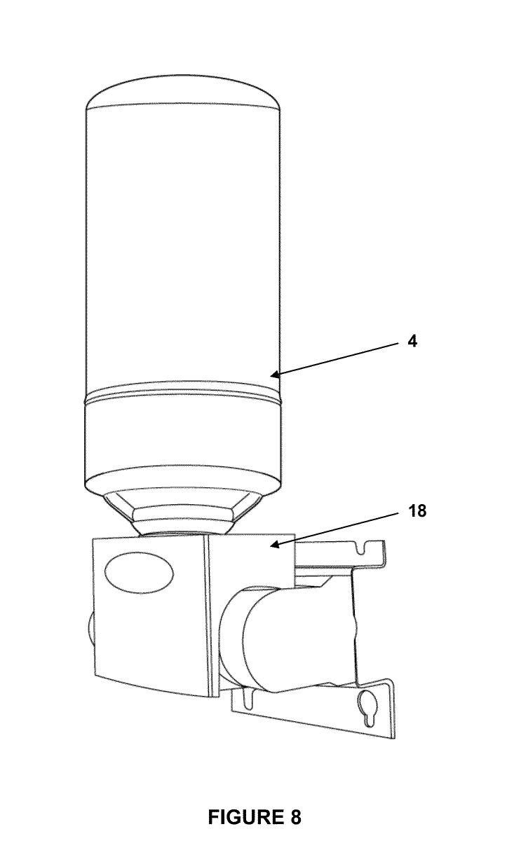

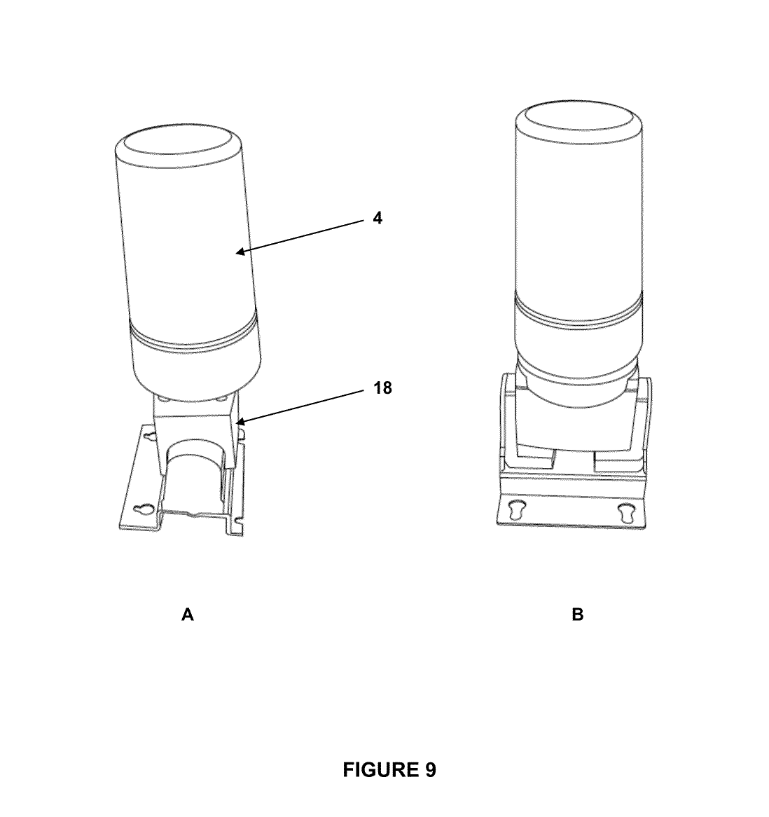

The invention provides that the bottled water dispensers 2 will further comprise a pump, which may be activated when a user wishes to dispense water. For example, if the bottled water dispenser 2 comprises a faucet, valve, or other well-known structure that may be operated to dispense water into a cup, upon the opening of the faucet, valve, or other structure, the pump may power on and force water out of the water bottle, through the filter 4, and eventually out of the faucet (through channels and tubes located within the bottled water dispenser 2). Because the bottled water dispenser will employ the use of such pump, the water filter 4 used in the present invention will not rely upon gravitational forces to move water through the water filter 4. The pressure and force provided by the pump also allows the water filter 4 to be positioned in any desirable manner within the bottled water dispenser 2, including in an inverted (upside down) fashion, since the water filter 4 does not rely upon gravitational force to move water through the water filter 4 (see, for example, FIGS. 8 and 9). In addition, as shown in FIG. 1, since gravitational forces are not required, the water filter 4 may be located above or to the side of the water bottle (i.e., it is not required for the water bottle to be located somewhere above the water filter 4).

In addition to the filters 4 described above, the invention encompasses the use of other modular filters 4 with the water dispensers 2 described herein. For example, various types of currently-available filtration cartridges may be used, such as basic sediment filters and/or activated carbon filters (which may be used to remove chlorine and other harmful contaminants from water). Still further, the invention provides that so-called ultra-fine (UF) filters may be used, which comprise a plurality of thin tubes and capillaries through which water is forced and filtered. The foregoing types of filters will require a port through which water enters the filter, and a port through which clean water exits the filter (similar to the embodiments described above). The invention further provides that reverse osmosis (RO) filters may be employed (which comprise a filter having micron holes located on the surface thereof). In the case of an RO filter, the filter would require a first port through which water enters the filter, a second port through which clean drinking water exists the filter, and a third port through which filtered and “rejected” water exits the filter and can then be drained and discarded (i.e., the water that cannot pass through the micron holes and, therefore, contains unwanted contaminants).

The many aspects and benefits of the invention are apparent from the detailed description, and thus, it is intended for the following claims to cover all such aspects and benefits of the invention, which fall within the scope and spirit of the invention. In addition, because numerous modifications and variations will be obvious and readily occur to those skilled in the art, the claims should not be construed to limit the invention to the exact construction and operation illustrated and described herein. Accordingly, all suitable modifications and equivalents should be understood to fall within the scope of the invention as claimed herein.

What is claimed is:

1. A bottled water dispenser, which comprises:
(a) a cabinet that comprises a top half and a bottom half, with a water bottle located in the bottom half;
(b) a pump that is configured to force water out of the water bottle, through one or more tubes, and out of a water faucet that is accessible from an exterior of the water dispenser cabinet; and
(c) a modular water filter that may be reversibly inserted into and removed from an interior area of the cabinet, wherein (i) water moves through the filter in response to a force that is supplied by the pump and not gravity forces and (ii) the filter is located adjacent to or above the water bottle.

2. The bottled water dispenser of claim 1, wherein the water filter comprises:
(a) a bottom container with an open top end;
(b) a cap portion with an open bottom end that is configured to be attached to the open top end of the bottom container; and
(c) an interior container which (i) resides within an interior area of the water filter when the bottom container and cap portion are connected to each other and (ii) comprises one or more filters through which water may pass within the water filter.

3. The bottled water dispenser of claim 2, which further comprises a water filter connector, which is configured to reversibly receive and be attached to a mouth portion of the cap portion, wherein water is allowed to travel through a channel located in the connector and into the water filter.

4. The bottled water dispenser of claim 3, wherein the bottled water dispenser is a bottom loading water dispenser.

5. The bottled water dispenser of claim 4, wherein the water filter comprises a space between (a) an outer wall that is formed when the bottom container and cap portion are connected to each other and (b) the interior container, wherein water is allowed to travel through said space and into an interior area of the interior container.

6. The bottled water dispenser of claim 5, wherein the one or more filters are accessible and are configured to receive water from within the interior area of the interior container.

7. The bottled water dispenser of claim 6, wherein a water inlet port and a water outlet port are both located on a topside of the connector.

8. The bottled water dispenser of claim 7, which further comprises a pump that generates sufficient pressure to cause water to travel from a water bottle, through the water filter, and out of a water faucet of the water dispenser.

9. The bottled water dispenser of claim 8, wherein the one or more filters are selected from the group consisting of a carbon filter, sediment filter, alkaline filter, and a combination of the foregoing filters.

10. The bottled water dispenser of claim 9, wherein the cap portion comprises an interior secondary cylinder, which is configured to receive and connect to a top end of the interior container.

11. A modular water filter and connector that are adapted to be inserted into a bottled water dispenser, wherein the water filter comprises:
(a) a bottom container with an open top end;
(b) a cap portion with an open bottom end that is configured to be attached to the open top end of the bottom container; and
(c) an interior container which (i) resides within an interior area of the water filter when the bottom container and cap portion are connected to each other and (ii) comprises one or more filters through which water may pass within the water filter, and wherein the connector is configured to reversibly receive and be attached to a mouth portion of the cap portion, wherein water is allowed to travel through a channel located in the connector and into the water filter.

12. The modular water filter and connector of claim 11, wherein each of the one or more filters exhibit a larger surface area on a side through which water enters, relative to a side through which water exits, each of the one or more filters.

13. The modular water filter and connector of claim 12, wherein the bottled water dispenser is a bottom loading water dispenser.

14. The modular water filter and connector of claim 13, wherein the water filter comprises a space between (a) an outer wall that is formed when the bottom container and cap portion are connected to each other and (b) the interior container, wherein water is allowed to travel through said space and into an interior area of the interior container.

15. The modular water filter and connector of claim 14, wherein the one or more filters are accessible and are configured to receive water from within the interior area of the interior container.

16. The modular water filter and connector of claim 15, wherein a water inlet port and a water outlet port are both located on a topside of the connector.

17. The modular water filter and connector of claim 16, which further comprises a pump that generates sufficient pressure to cause water to travel from a water bottle, through the water filter, and out of a water faucet of the bottled water dispenser.

18. The modular water filter and connector of claim 17, wherein the one or more filters are selected from the group consisting of a carbon filter, sediment filter, alkaline filter, and a combination of the foregoing filters.

19. The modular water filter and connector of claim 18, wherein the cap portion comprises an interior secondary cylinder, which is configured to receive and connect to a top end of the interior container.

20. The modular water filter and connector of claim 19, wherein the interior secondary cylinder of the cap portion frictionally engages and connects to the top end of the interior container.
